(19) United States
(12) Patent Application Publication
(10) Pub. No.: US 2012/0146597 A1
(43) Pub. Date: Jun. 14, 2012

(54) POWER SUPPLY APPARATUS

(75) Inventors: Takahiko SHIMIZU, Tokyo (JP); Katsuhiko DEGAWA, Tokyo (JP)

(73) Assignee: ADVANTEST CORPORATION, Tokyo (JP)

(21) Appl. No.: 13/311,391

(22) Filed: Dec. 5, 2011

(30) Foreign Application Priority Data
Dec. 9, 2010 (JP) 2010-274560

(51) Int. Cl. G05F 1/46

(52) U.S. Cl. 323/265

(57) ABSTRACT

A load capacitor is connected to a power supply terminal of a DUT. A current detection unit detects an output current output from a power supply apparatus. A nonlinear control unit controls its output amount so as to provide a balance between an amount of charge with which the load capacitor is charged or discharged in a first period, from a first timing at which a change occurs in a load current that flows into the power supply terminal of the DUT until a second timing at which the load current matches the output current, and an amount of charge with which the load capacitor is charged or discharged in a second period, from the second timing until a third timing at which the control operation ends.

### BACKGROUND OF THE INVENTION

1. Field of the Invention

The present invention relates to a power supply apparatus configured to supply electric power to a semiconductor device.

2. Description of the Related Art

A test apparatus includes a power supply apparatus configured to supply a power supply voltage or power supply current (which will be referred to as the “power supply voltage Vdd” hereafter) to a device under test (DUT). FIG. 1 is a block diagram which shows a schematic configuration of a conventional power supply apparatus. A power supply apparatus 1100 includes a power supply output unit 1026 and a frequency controller (which will be referred to as the “controller” hereafter) 1024 configured to control the power supply output unit 1026. For example, the power supply output unit 1026 is configured as an operational amplifier (buffer), a DC/DC converter, a linear regulator, or a constant current source, and is configured to generate a power supply voltage or a power supply current (output signal OUT) to be supplied to the DUT 1.

A decoupling capacitor C1 is arranged in the vicinity of the power supply terminal of the DUT 1. Furthermore, the output terminal of the power supply apparatus 1100 and the power supply terminal of the DUT 1 are connected via a cable. With such an arrangement, the target to be stabilized by the power supply apparatus 1100 is not the output signal OUT of the power supply output unit 1026, but in actuality is the power supply voltage Vdd applied to the power supply terminal of the DUT 1. With conventional techniques, the controller 1024 outputs a control value such that the difference between the observed value (control target) that is fed back and a predetermined reference value becomes zero. Examples of the observed values include a feedback signal that corresponds to the power supply voltage or the power supply current supplied to the DUT 1. For example, a circuit element 1022 indicated by the subtractor symbol in FIG. 1 is configured as an error amplifier (operational amplifier), and is configured to amplify the difference between the observed value and the reference value. The analog controller 1024 generates a control value such that the difference becomes zero. The state of the power supply output unit 1026 is feedback controlled according to the control value thus generated. As a result, the power supply voltage Vdd to be controlled is stabilized to the target value. The parameters that are to be considered when the control target 1010 is controlled are represented by a parasitic parameter 1030, which is a symbolic parameter. The parasitic parameter 1030 includes a parasitic resistor, a parasitic capacitance, a parasitic inductance, and so forth, of the power supply cable and each of the internal components of the power supply apparatus 1100.

### [Related Art Documents]

### [Patent Documents]

### [Patent Document 1]

PCT Japanese Translation Patent Publication No. 2004-529400

### [Patent Document 2]

Japanese Patent Application No. 2526859

### [Patent Document 3]

Japanese Patent Application Laid Open No. H05-313760

### [Patent Document 4]

Japanese Patent Application Laid Open No. H02-123986

### [Patent Document 5]

Japanese Patent Application Laid Open No. H09-178820

With conventional techniques, the controller 1024 is configured employing an analog circuit. Accordingly, the overall performance of the controller 1024 is fixedly determined by the performance of the analog elements that form the analog circuit, which is a problem. Furthermore, the control target 1010 is subject to the effects of fluctuation in the load current and the decoupling capacitor C1 arranged in the vicinity of the control target 1010. In addition, in a case in which the controller 1024 is designed giving consideration to the effects of the parasitic parameter 1030, such an arrangement leads to a complicated configuration and an increase in the number of circuit components, which is also a problem.

### SUMMARY OF THE INVENTION

The present invention has been made in order to solve such a problem. Accordingly, it is an exemplary purpose of an embodiment of the present invention to provide a power supply apparatus which is capable of stably supplying electric power to a semiconductor device.

An embodiment of the present invention relates to a power supply apparatus configured to supply electric power via a power supply line to a semiconductor device having a power supply terminal connected to a capacitor. The power supply apparatus comprises: a current detection unit configured to detect an output current output from the power supply apparatus; and a nonlinear control unit configured to control its output amount so as to provide a balance between an amount of charge with which the capacitor is charged or discharged in a first period, from a first timing at which a change occurs in a load current that flows into the power supply terminal of the semiconductor device until a second timing at which the load current matches the output current, and an amount of charge with which the capacitor is charged or discharged in a second period, from the second timing until a third timing at which the control operation ends.

With such an embodiment, the amount of charge with which the capacitor is charged and the amount of charge with which the capacitor is discharged are appropriately calculated, and the output amount is controlled such that the amount of charge with which the capacitor is charged (discharged) in the first period matches the amount of charge with which the capacitor is discharged (charged) in the second period. Thus, such an arrangement is capable of suppressing fluctuation in the power supply voltage, or provides a reduction in the period of time required to stabilize fluctuation in the power supply voltage. Alternatively, such an arrangement is capable of providing an intentional change in the power supply voltage, and of controlling a period of time required to stabilize the power supply voltage as desired.

Also, a power supply apparatus according to an embodiment may further comprise: a linear control unit configured to control its output amount such that the power supply voltage at the power supply terminal matches a predetermined reference voltage; a load fluctuation detection unit configured to detect a change in the load; and a selector configured to receive the output amount of the linear control unit and the output amount of the nonlinear control unit, to select one from among the output amounts thus received according to detection results obtained by the load fluctuation detection unit, and to output the output amount thus selected.

With such an embodiment, by switching the control operation between the linear control operation and the nonlinear control operation according to the state of the load, such an arrangement provides further stabilization of the power supply voltage.

Another embodiment of the present invention relates to a test apparatus. The test apparatus comprises a power supply apparatus according to any one of the aforementioned embodiments, configured to supply electric power to a device under test.

It is to be noted that any arbitrary combination or rearrangement of the above-described structural components and so forth is effective as and encompassed by the present embodiments. Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram which shows a schematic configuration of a conventional power supply apparatus;

FIG. 2 is a block diagram which shows a test apparatus including a power supply apparatus according to an embodiment;

FIG. 3 is a waveform diagram which shows the operation in a nonlinear control mode provided by a nonlinear control unit shown in FIG. 2;

FIG. 4 is a block diagram which shows a specific example configuration of the power supply apparatus shown in FIG. 2;

FIG. 5 is a state transition diagram regarding the power supply apparatus shown in FIG. 2;

FIG. 6 is a time chart which shows a first control operation of the power supply apparatus shown in FIG. 2;

FIG. 7 is a diagram which shows an algorithm of a control operation performed in a first period;

FIGS. 8A and 8B are diagrams each showing an algorithm of a control operation performed in a second period;

FIG. 9 is a time chart which shows a second control operation of the power supply apparatus shown in FIG. 2; and

FIG. 10 shows simulation waveform diagrams of a power supply voltage and an output current when the second control operation is performed.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not substantially affect the electric connection therebetween, or that does not damage the functions or effects of the connection therebetween, in addition to a state in which the member A is physically and directly connected to the member B.

Similarly, the state represented by the phrase “the member C is provided between the member A and the member B” includes a state in which the member A is indirectly connected to the member C, or the member B is indirectly connected to the member C via another member that does not substantially affect the electric connection therebetween, or that does not damage the functions or effects of the connection therebetween, in addition to a state in which the member A is directly connected to the member C, or the member B is directly connected to the member C.

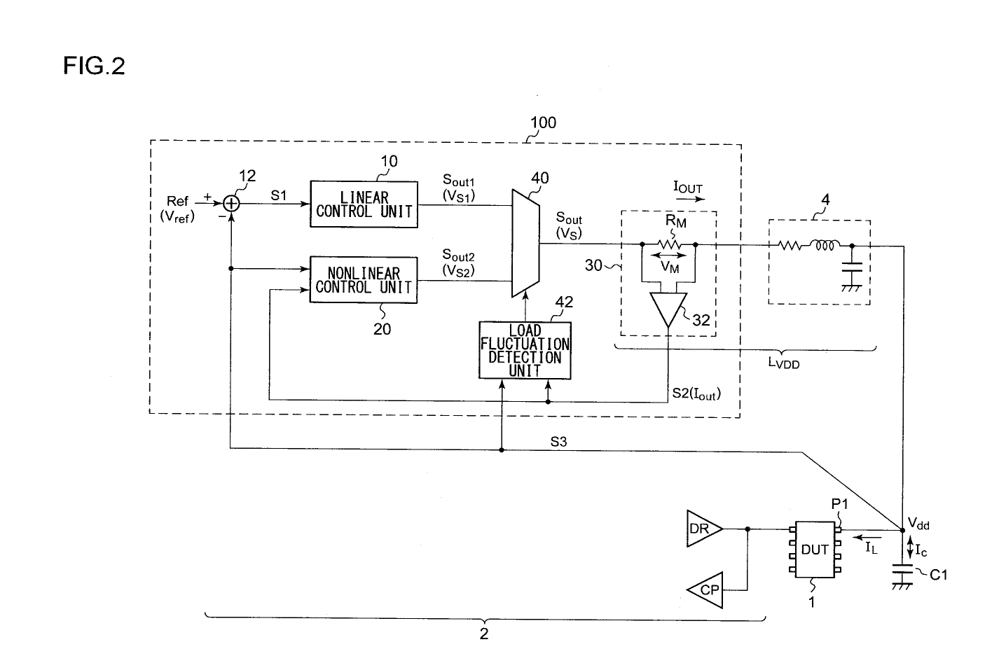

FIG. 2 is a block diagram which shows a test apparatus 2 including a power supply apparatus 100 according to an embodiment. The test apparatus 2 is configured to supply a signal to a DUT 1, and to compare a signal received from the DUT 1 with an expected value so as to judge the quality of the DUT 1 or to identify defective parts of the DUT 1.

The test apparatus 2 includes a driver DR, a comparator (timing comparator) CP, a power supply apparatus 100, and so forth. The driver DR is configured to output a test signal to the DUT 1. The test signal is generated by an unshown timing generator TG, pattern generator PG, waveform shaper FC, and so forth (none of which is shown in the drawing), and is input to the driver DR. The signal output from the DUT 1 is input to the comparator CP. The comparator CP compares the signal received from the DUT 1 with a threshold value, and latches the comparison result at an appropriate timing. The output of the comparator CP is compared with its expected value. The above is the schematic configuration of the test apparatus 2.

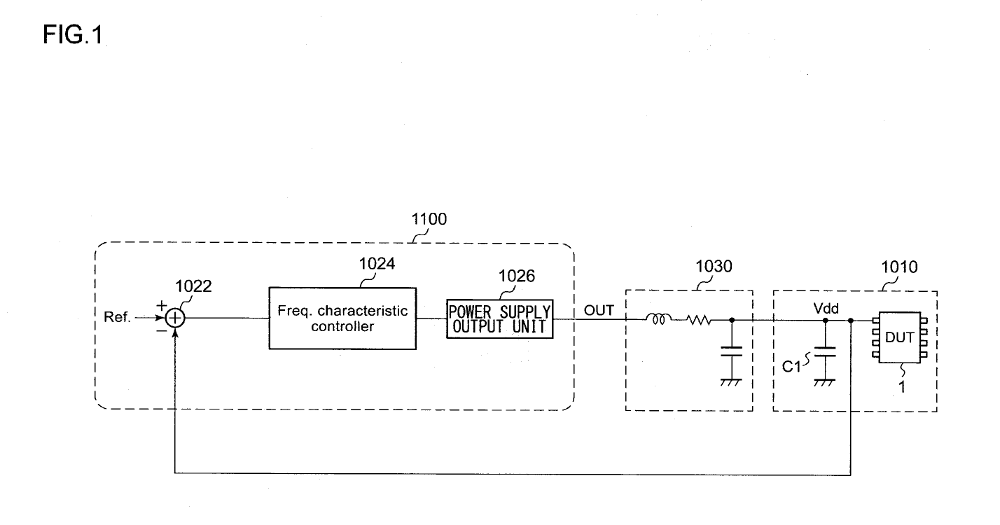

Detailed description will be made regarding the power supply apparatus 100 according to an embodiment. The power supply apparatus 100 is connected to the power supply terminal P1 of the DUT 1 via a power supply line L_{VDD}. A bypass capacitor (capacitor C1) is connected in the vicinity of the power supply terminal P1 of the DUT 1. It should be noted that the combined capacitance obtained by combining the capacitor C1, the parasitic capacitance of the power supply line L_{VDD}, the capacitance that occurs between the power supply terminal P1 and the substrate, and so forth, shown in FIG. 2, will be collectively referred to as the “load capacitance C_{L}”. It should be noted that, in the control operation of the power supply apparatus 100 according to the embodiment, the load capacitance C_{L} is required to be a known value. Accordingly, the value of the load capacitance C_{L} is obtained beforehand by actual measurement, simulation, or the like. The voltage supplied to the power supply terminal P1 will be referred to as the “power supply voltage Vdd”. A parasitic parameter 4 symbolically represents parameters that are to be considered when the output amount V_{S} is controlled, as with an arrangement as described with reference to FIG. 1. That is to say, the parasitic parameter 4 is not an explicit element that actually exits in the circuit.

The power supply apparatus 100 includes a linear control unit 10, an adder 12, a nonlinear control unit 20, a current detection unit 30, a selector 40, and a load fluctuation detection unit 42. The power supply apparatus 100 may be configured as an analog circuit, a digital circuit, or an analog/digital hybrid circuit.

The power supply apparatus 100 controls its output amount S_{OUT}, according to the state of the load. The output amount S_{OUT} represents either the output voltage V_{S} or the output current Iₒᵤₜ, or represents both of them. The power supply apparatus 100 is configured to be switchable between the linear control mode φ_{L} and the nonlinear mode φ_{NL}. In the linear control mode φ_{L}, the selector 40 selects the output amount S_{OUT1} (output voltage V_{S1}) of the linear control unit 10. In the nonlinear control mode φ_{NL}, the selector 40 selects the output amount S_{OUT2} (output voltage V_{S2}) of the nonlinear control unit 20. The selector 40 outputs the output amount thus selected as the output amount S_{OUT} (output voltage V_{S}). The load fluctuation detection unit 42 controls the selector 40 according to a signal which indicates the state of the DUT 1, such as the output current I_{OUT} or the power supply voltage Vdd supplied from the power supply apparatus 100 to the DUT 1, thereby switching the control mode between the linear control mode φ_{L} and the nonlinear control mode φ_{NL}.

1. Linear Control Mode φ_{L}

In the linear control mode φ_{L}, the output voltage V_{S1} is controlled mainly by the adder 12 and the linear control unit 10. The adder 12 generates a difference signal S1 which indicates the difference between the power supply voltage Vdd and its target value V_{ref}. The linear control unit 10 controls its output voltage V_{S1} (output amount) using a conventional linear control method such that the difference indicated by the difference signal S1 becomes zero, i.e., such that the power supply voltage Vdd matches the target value V_{ref}. In a case in which the linear control unit 10 is configured as a digital circuit, a PI control operation or a PID control operation is performed. In a case in which the linear control unit 10 is configured as an analog circuit, the adder 12 may be configured as an error amplifier (operational amplifier), and the linear control unit 10 may be configured as a linear regulator or a switching regulator (DC/DC converter).

2. Nonlinear Control Mode φ_{NL}

In the nonlinear control mode φ_{NL}, the output voltage V_{S2} is mainly controlled by the nonlinear control unit 20 and the current detection unit 30.

The current detection unit 30 detects the output current I_{OUT} output from the power supply apparatus 100 to the DUT 1. For example, the current detection unit 30 may include a detection resistor R_{M} arranged on a path of the output current I_{OUT} and an amplifier 32 configured to amplify and detect the voltage drop V_{M} that occurs at the detection resistor R_{M}. The current detection unit 30 outputs an output current detection signal S2 which indicates the output current I_{OUT}.

The nonlinear control unit 20 receives a voltage detection signal S3 which indicates the power supply voltage Vdd and the output current detection signal S2 which indicates the output current I_{OUT}, and controls its output amount S_{OUT2} according to the detection signals thus received. Description will be made separately regarding the operations of the nonlinear control unit 20 in a first period τ1 and a second period τ2.

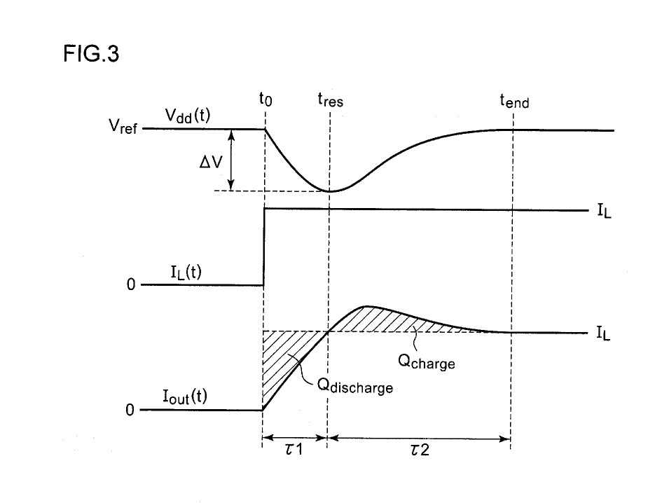

FIG. 3 is a waveform diagram which shows the operation in the nonlinear control mode φ_{NL}, which is provided by the nonlinear control unit 20 shown in FIG. 2. The first period τ1 is a period from a first timing t₀, at which the load current I_{L} that flows into the power supply terminal P1 of the DUT 1 changes, up to a second timing tᵣₑₛ, at which the load current I_{L} matches the output current I_{OUT}. The second period τ2 is a period from the second timing tᵣₑₛ up to a third timing t_{end} at which the control operation ends.

Before the time point t₀, the power supply apparatus 100 is in a static state in which the output voltage V_{S} is stabilized in the linear control mode φ_{L}. Let us say that, when t<t₀, the load current I_{L} and the output current I_{OUT} are each zero, and at the time point t₀, the load sharply increases from zero to a certain level. Upon detecting such a situation, the power supply apparatus 100 transits to the nonlinear control mode φ_{NL} provided by the nonlinear control unit 20.

During the first period τ1, the relation I_{L}>I_{OUT} holds true. Accordingly, a current I_{C}=(I_{L}−I_{OUT}) which matches the current shortfall is supplied from the load capacitor C_{L} to the power supply terminal of the DUT 1. That is to say, the capacitor C_{L} is discharged by the charging/discharging current I_{C}=I_{L}−I_{OUT}. The discharge amount Q_{discharge} is represented by the hatched area in the first period τ1 in FIG. 3. After the load capacitor C_{L} is discharged during the first period τ1, the power supply voltage Vdd drops by ΔV as compared with that in the static state.

After the second timing tᵣₑₛ, the relation I_{L}<Iₒᵤₜ holds true. In this state, the load capacitor C_{L} is charged with the current I_{C}=I_{OUT}−I_{L}, thereby increasing the power supply voltage Vdd. The charging amount Q_{charge} is represented by the hatched area in the second period τ2 in FIG. 3.

The nonlinear control unit 20 controls its output amount Sₒᵤₜ, i.e., the output voltage V_{S2} and the output current Iₒᵤₜ, so as to provide a balance (matching) between an amount of charge Q_{discharge} with which the load capacitor C_{L} is charged or discharged in the first period τ1 and an amount of charge Q_{charge} with which the load capacitor C_{L} is charged or discharged in the second period τ2.

The relation Expressions (1) and (2) hold true between the load current I_{L}, the output current I_{OUT}, the discharging amount Q_{discharge}, and the charging amount Q_{charge}. With such an arrangement, the output amount Sₒᵤₜ is controlled such that Expression (3) holds true, thereby restoring the power supply voltage Vdd to the target voltage V_{ref}.

[symbol]

[Expression 1]

By means of such a nonlinear control operation by the nonlinear control unit 20, at the time point t_{end}, the power supply voltage Vdd becomes the same as the reference voltage V_{ref}. After the load enters the static state, the control operation is switched from the nonlinear control operation to the linear control operation.

It should be noted that description will be made regarding the present embodiment directing attention to a case in which the load current I_{L} sharply increases from a given level.

If the linear control operation is continued even after a sharp change occurs in the load, a long period of time is required to restore the power supply voltage Vdd to the target voltage V_{ref} due to the insufficient response speed of the feedback operation. Furthermore, such an arrangement leads to an increase in the amount of power supply voltage drop ΔV. In contrast, with the power supply apparatus 100 shown in FIG. 2, when a sharp change occurs in the load, such an arrangement performs the nonlinear control operation according to the amount of charge, thereby providing a reduction in the time required to restore the power supply voltage Vdd to the initial stable level. It should be noted that description will be made later regarding a comparison between the linear control operation and the nonlinear control operation with respect to the amount of power supply voltage drop ΔV and the restoration time (stabilization time).

Next, description will be made regarding a specific operation and an example configuration of the nonlinear control unit 20.

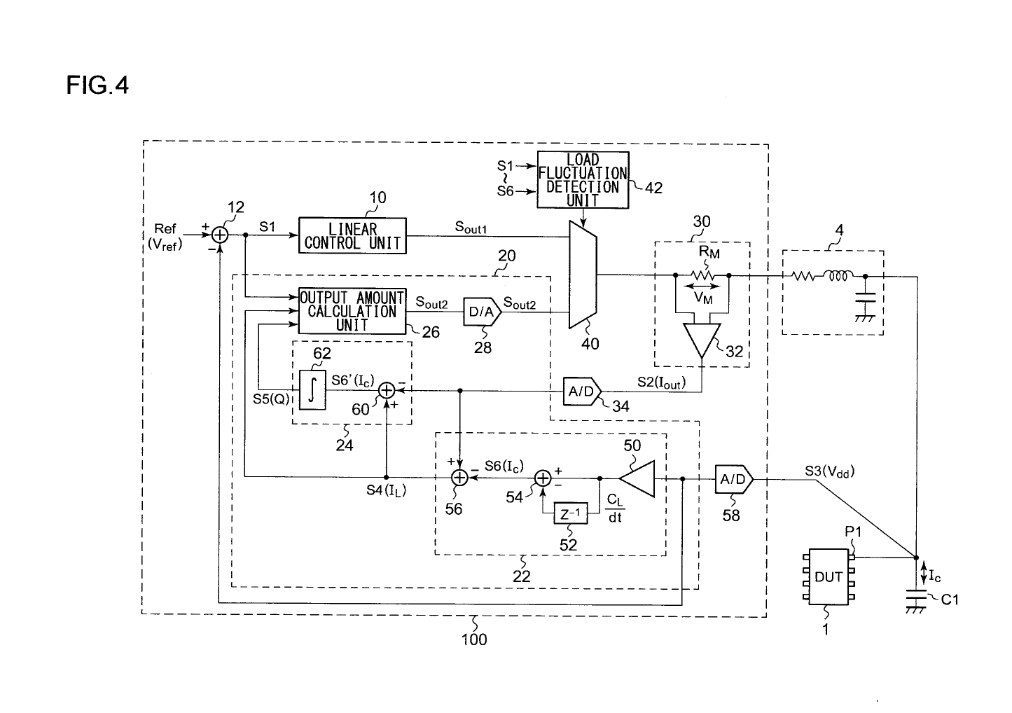

FIG. 4 is a block diagram which shows a specific example configuration of the power supply apparatus 100 shown in FIG. 2. FIG. 4 shows an arrangement in which the power supply apparatus 100 is configured as a digital circuit.

A/D converters 34 and 58 respectively convert the analog output current detection signal S2 and the analog voltage detection signal S3 into digital signals. The nonlinear control unit 20 includes a load current calculation unit 22, a charge amount calculation unit 24, an output amount calculation unit 26, and a D/A converter 28. The D/A converter 28 converts the output amount Sₒᵤₜ₂ output from the output amount calculation unit 26 in the form of digital data into the output amount Sₒᵤₜ₂ in the form of analog data. The D/A converter 28 may be configured as a voltage DAC or a current DAC. In the former case, the output amount Sₒᵤₜ₂ is configured as the output voltage V_{S}. In the latter case, the output amount Sₒᵤₜ₂ is configured as the output current Iₒᵤₜ.

The load current calculation unit 22 calculates the load current I_{L} that flows into the power supply terminal P1 of the DUT 1, and generates a load current detection signal S4 which indicates the load current I_{L} thus calculated. The charge amount calculation unit 24 calculates the amount of charge Q with which the load capacitor C_{L} is charged or discharged, and generates a charge amount detection signal S5 which indicates the amount of charge Q thus calculated. The output amount calculation unit 26 calculates the output amount Sₒᵤₜ₂ based upon the load current I_{L} indicated by the load current detection signal S4 and the amount of charge Q indicated by the charge amount detection signal S5 so as to provide a balance between the amount of charge calculated for the first period τ1 and the amount of charge calculated for the second period τ2.

The load current calculation unit 22 multiplies the differential value dVdd/dt of the power supply voltage Vdd by the capacitance value of the load capacitor C_{L} so as to generate a charging/discharging current detection signal S6 which indicates the charging/discharging current I_{C} that flows into or from the load capacitor C_{L}. As described above, the charging/discharging current I_{C} is represented by the difference between the load current I_{L} and the output current Iₒᵤₜ. With such an arrangement, the load current calculation unit 22 subtracts the charging/discharging current I_{C}(S6) from the output current Iₒᵤₜ(S2) so as to generate the load current detection signal S4 which indicates the load current I_{L}.

The load current calculation unit 22 may include a multiplier 50 configured to multiply the voltage detection signal S3 by a coefficient C_{L}/dt, a delay circuit 52 configured to delay the output of the multiplier 50 by one sampling time, an adder 54 configured to calculate the difference between the output of the multiplier 50 and the output of the delay circuit 52, and a subtractor 56 configured to subtract the output of the adder 54 from the output current detection signal S2. Here, dt represents the one sampling time.

The charge amount calculation unit 24 integrates the difference between the load current I_{L} and the output current Iₒᵤₜ, i.e., integrates the charging/discharging current I_{C}, thereby calculating the amount of charge Q. The charge amount calculation unit 24 may include: an adder 60 configured to subtract the output current detection signal S2 from the load current detection signal S4 so as to calculate a charging/discharging current detection signal S6′; and a integrator 62 configured to integrate the output of the adder 60 so as to generate the charge amount detection signal S5. It should be noted that the adder 60 may be omitted, and the charging/discharging current detection signal S6, which is the output of the adder 54, may be input to the integrator 62.

Next, description will be made regarding a specific operation of the output amount calculation unit 26.

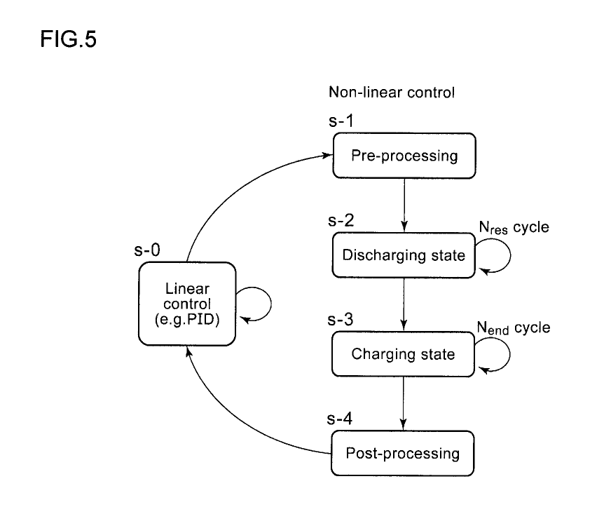

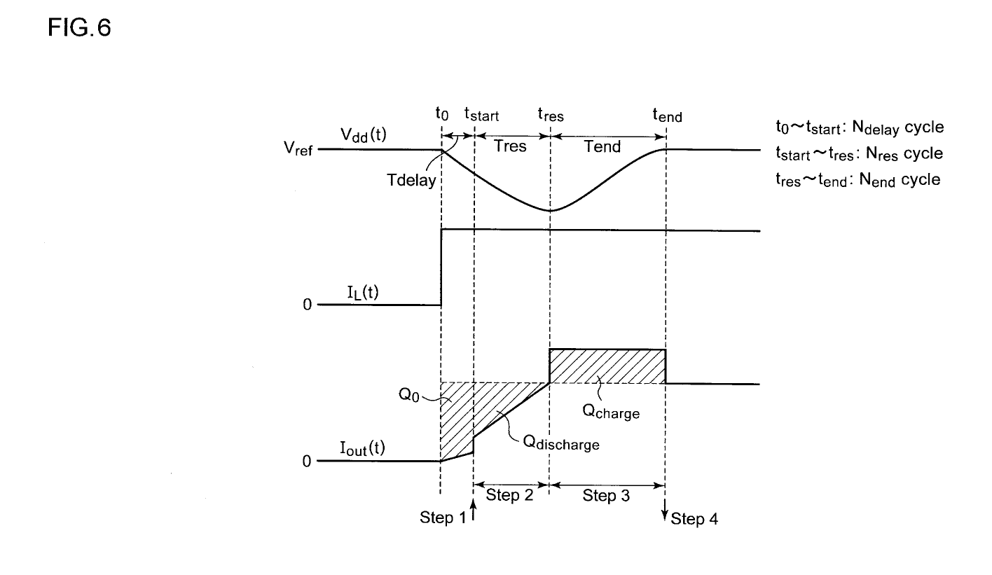

FIG. 5 is a state transition diagram regarding the power supply apparatus 100 shown in FIG. 2. FIG. 6 is a time chart which shows a first control operation of the power supply apparatus 100 shown in FIG. 2.

In FIG. 5, s-0 represents a linear control mode φ_{L}, and s-1 through s-4 each represent a nonlinear control mode φ_{NL}. When the system is in the static state, the mode is set to the linear control mode φ_{L}, in which a linear control operation is performed in the state s-0. When a change occurs in the load, and when this change is detected by the load fluctuation detection unit 42, the state transits to the state s-1. Description will be made below regarding examples of detection conditions on the basis of which the load fluctuation detection unit 42 detects the change in the load.

1. Detection Based on the Difference Signal S1 (V_{ref}−Vdd)

When the difference between the target voltage V_{ref} and the power supply voltage Vdd exceeds a predetermined threshold value Vₜₕ, the load fluctuation detection unit 42 may judge that a change has occurred in the load.

2. Detection Based on the Output Current Detection Signal S2 (Iₒᵤₜ)

When the output current Iₒᵤₜ exceeds a predetermined threshold value Iₜₕ, the load fluctuation detection unit 42 may judge that a change has occurred in the load.

3. Detection Based on the Charging/Discharging Current Detection Signal S6 (I_{C})

When the charging/discharging current I_{C} has become a substantially nonzero value, or when the absolute value of the charging/discharging current I_{C} exceeds a predetermined threshold value, the load fluctuation detection unit 42 may judge that a change occurs in the load.

4. Detection Based on the Rate of Change With Respect to Time (dI_{L}/dt) in the Load Current Detection Signal S4 (Load Current I_{L})

When the rate of change (differential value) of the load current I_{L} with respect to time has become a substantially nonzero value, or when the absolute value of the differential value exceeds a predetermined threshold value, the load fluctuation detection unit 42 may judge that a change has occurred in the load.

5. Detection Based on the Load Current Detection Signal S4 (load current I_{L})

When the load current I_{L} exceeds a predetermined threshold value, the load fluctuation detection unit 42 may judge that a change has occurred in the load.

That is to say, the load fluctuation detection unit 42 may preferably detect a sharp change in the load (transition from a static state to a transient state) using any one of such methods.

A certain delay occurs from the time point at which a change occurs in the load up to a timing tₛₜₐᵣₜ at which the load fluctuation detection unit 42 detects the change in the load and the nonlinear control operation is started. During the delay period, the linear control unit 10 performs the linear control operation. In the state s-1, an initial amount of charge Q₀, which is an amount of charge with which the load capacitor C_{L} is to be discharged during the delay period, is calculated, which is a pre-processing step for the subsequent nonlinear control operation.

If the linear control operation has a slow response speed, calculation can be made assuming that the output current Iₒᵤₜ is zero during a period from the time point t₀ up to the time point tₛₜₐᵣₜ. With the delay time T_{delay} as the number of cycles N_{delay} in units of the system sampling time T_{S}, the initial amount of charge Q₀ can be calculated based upon Expression (4). A predetermined value may be used as the number of cycles N_{delay}. Also, the number of cycles N_{delay} may be estimated based upon the value of the slope of the power supply voltage Vdd curve and the value of the power supply voltage Vdd at the time point tₛₜₐᵣₜ.

[symbol]

[Expression 2]

Alternatively, instead of using the aforementioned approximate expression to calculate the initial amount of charge Q₀, a more detailed calculation may be made. Also, in a case in which the delay time T_{delay} is sufficiently short, the calculation of the initial amount of charge Q₀ may be omitted.

Subsequently, the state transits to the state s-2, in which the processing that corresponds to the aforementioned first period τ1 is performed. With the present embodiment, the length Tᵣₑₛ of the first period τ1 is determined beforehand to be Nᵣₑₛ, which is the number of signal processing cycles. During the first period τ1 (Tᵣₑₛ=T_{S}×Nᵣₑₛ), the output amount Sₒᵤₜ is controlled such that the length of the first period τ1 matches such a predetermined value, i.e., the output current Iₒᵤₜ matches the load current I_{L} after the end of the Nᵣₑₛ cycles of signal processing from the start of the control operation.

During the first period τ1, the output amount calculation unit 26 controls the output amount Sₒᵤₜ such that there is a monotonic change (change with a constant slope α) in the output current Iₒᵤₜ. If the output current Iₒᵤₜ at the time point tₛₜₐᵣₜ is approximated as being zero, the slope α of the output current Iₒᵤₜ curve is represented by I_{L}/Tᵣₑₛ=I_{L}/(tᵣₑₛ−tₛₜₐᵣₜ).

That is to say, the output current Iₒᵤₜ in the first period τ1 is represented by the following Expression.

Iₒᵤₜ(t)=I_{L}/Tᵣₑₛ=I_{L}×(tᵣₑₛ−tₛₜₐᵣₜ) (5)

By discretization of the current in the time direction, the slope α of the output current Iₒᵤₜ is represented by I_{L}/(T_{S}×Nᵣₑₛ).

In the k-th cycle in the state s-2, the following Expressions (6) and (7) hold true.

t=tₛₜₐᵣₜ+k×T_{S} (6)

Iₒᵤₜ(tₛₜₐᵣₜ+kT_{S})=I_{L}/Nᵣₑₛ×k (7)

If, for ease of understanding and simplicity of description, the parasitic parameter 4 is taken to be negligible, the following Expression (8) holds true between the output voltage V_{S2} and the output current Iₒᵤₜ. Thus, in a case in which the output stage of the nonlinear control unit 20 is configured as a voltage source, such a voltage source may preferably generate an output voltage V_{S2} which satisfies Expression (8).

V_{S}(t)=Iₒᵤₜ(t)×R_{M}+Vdd(t) (8)

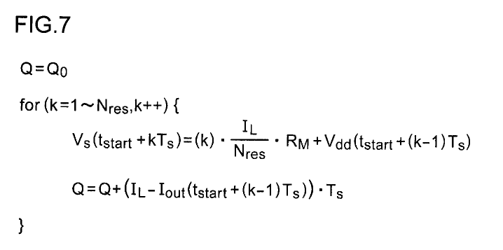

FIG. 7 is a diagram which shows a control algorithm in the first period. In the state s-2, the output voltage V_{S} may preferably be controlled according to the algorithm (source code) shown in FIG. 7. Furthermore, the discharged charge amount Q is updated with every cycle. By means of the algorithm shown in FIG. 7, such an arrangement allows the output current Iₒᵤₜ to match the load current I_{L} after Nᵣₑₛ cycles.

It should be noted that, in a case in which the output stage of the nonlinear control unit 20 is configured as a current source, the output amount Sₒᵤₜ may preferably be changed according to Expression (7). In this case, the calculation represented by Expression (8) becomes unnecessary.

Subsequently, the state transits to the state s-3 in which an operation that corresponds to the second period τ2 is performed. With the present embodiment, the length of the second period τ2 is also determined beforehand as the number of cycles N_{end}. In the second period τ2, the following operation is performed.

During the second period τ2, the output amount calculation unit 26 controls the output amount Sₒᵤₜ such that the output current Iₒᵤₜ is maintained at a constant level. That is to say, the output current Iₒᵤₜ required to charge the load capacitor C_{L} for a given length T_{end} (=t_{end}−tᵣₑₛ) of the second period τ2 with an amount of charge that matches the discharged charge amount Q_{discharge} calculated for the first period τ1 (state s-2) is represented by the following Expression (9).

Iₒᵤₜ=Q_{discharge}/T_{end} (9)

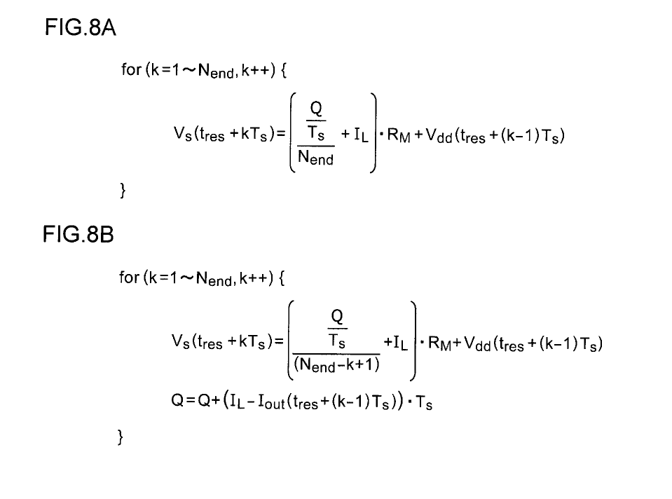

FIGS. 8A and 8B are diagrams each showing a control algorithm used in the second period. With the control algorithm shown in FIG. 8A, the amount of charge is not updated with every cycle, and the output voltage V_{S} that corresponds to Expression (9) is repeatedly calculated. With the control algorithm shown in FIG. 8B, the amount of charge is updated with every cycle, and the amount of current represented by Expression (9) is repeatedly calculated using the amount of charge is thus updated.

After the processing ends at the time point t_{end}, the state transits to the state s-4. The output voltage V_{S} at the time point at which the processing ends reaches the ideal control amount I_{L}·R_{M}+V_{ref}, at which the power supply voltage Vdd is ideally equal to V_{ref}. In practice, taking into account the margin of error, the control operation is preferably returned to the linear control operation in the state s-0 after the ideal control amount of the output voltage V_{S} is output for several cycles.

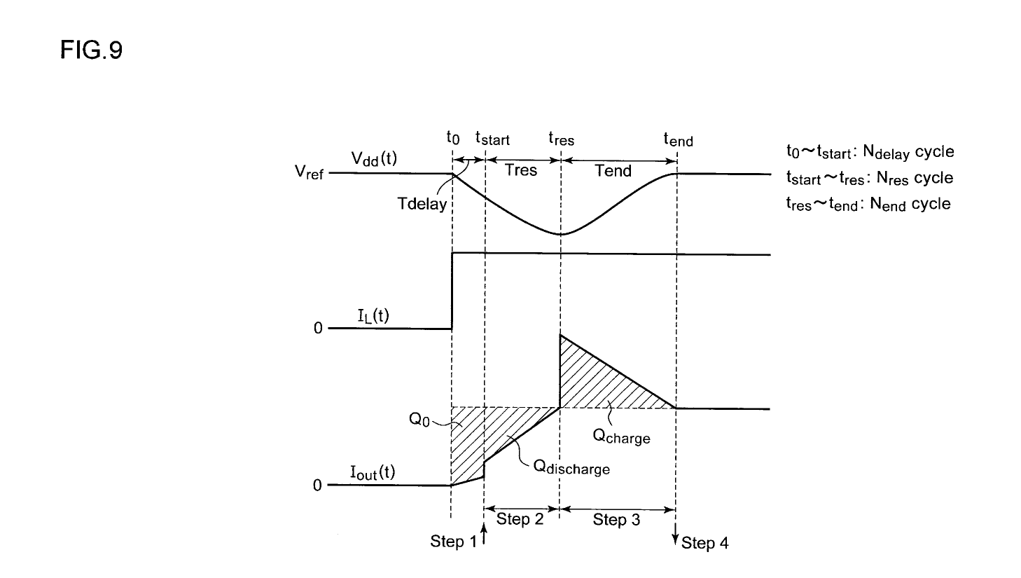

FIG. 9 is a time chart which shows a second control operation of the power supply apparatus 100 shown in FIG. 2. In the time chart shown in FIG. 9, the operation in the second period τ2 is different from that shown in the time chart in FIG. 6.

During the second period τ2, the output amount calculation unit 26 controls the output amount Sₒᵤₜ such that there is a monotonic change in the output current Iₒᵤₜ, and such that the output current Iₒᵤₜ becomes equal to the load current I_{L} at the third timing t_{end}, which is the endpoint of the second period τ2.

In the second period τ2, with the amount of charge Q to be charged as Q, and with the length of the second period τ2 as (t_{end}−tᵣₑₛ), the following relation expression may preferably be satisfied.

(Iₒᵤₜ(tᵣₑₛ)−I_{L})×T_{end}/2=Q (10)

From the aforementioned Expression (10), the output current Iₒᵤₜ at the time point tᵣₑₛ is represented by the following Expression (11).

Iₒᵤₜ(tᵣₑₛ)=Q×2/T_{end}+I_{L} (11)

Furthermore, the slope β of the output current Iₒᵤₜ curve in the second period τ2 is represented by the following Expression (12).

β=Q×2/T_{end}² (12)

Thus, the output current Iₒᵤₜ(t) in the second period τ2 is represented by the following Expression (13).

Iₒᵤₜ(t)=Q×2/T_{end}+I_{L}−β×(t−tᵣₑₛ) (13)

By discretization of the aforementioned Expression (13) using the relation T_{end}=N_{end}×T_{S} and t=tᵣₑₛ+kT_{S}, the following Expression (14) is obtained.

Iₒᵤₜ(t)=Q×2/(T_{S}×N_{end})×{1+k/N_{end}}+I_{L} (14)

The output amount calculation unit 26 calculates the output voltage V_{S} for the cycle k using Expressions (8) and (14), and outputs the calculation result of the output voltage V_{S} to the D/A converter 28.

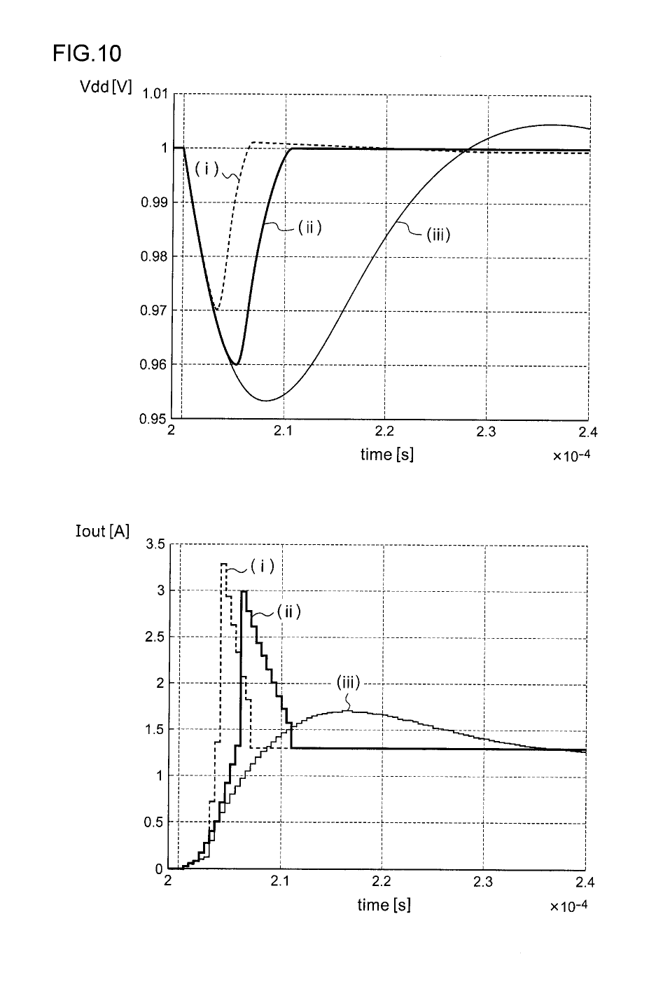

FIG. 10 shows simulation waveform diagrams of an output voltage Vdd and an output current Iₒᵤₜ in a case in which the second control operation is performed. FIG. 10 shows a case in which the second control operation is performed at a sampling frequency f_{S}=2 MHz when the load current I_{L} changes from 0 A to 1.3 A at the time point t=20 μs. The simulated results are shown assuming that the load capacitance C_{L} is 120 μF and R_{M} is 0.2 Ω.

The waveform (i) shows a case in which Nᵣₑₛ=N_{end}=7, i.e., a case in which a total of 14 cycles of signal processing are performed. The waveform (ii) shows a case in which Nᵣₑₛ=N_{end}=11, i.e., a case in which a total of 22 cycles of signal processing are performed. The waveform (iii) shows a case in which a linear control operation (PID control operation) is performed. There is not necessarily a need to set the length determined by Nᵣₑₛ and the length determined by N_{end} to be the same. Rather, Nᵣₑₛ and N_{end} can be determined independent of each other. As described above, with the power supply apparatus 100 according to the embodiment, by performing such a nonlinear control operation using such a capacitance balance method when a change occurs in the load, such an arrangement provides reduced fluctuation in the output voltage Vdd, and/or provides a reduction in the period of time required to stabilize the output voltage Vdd, as compared with an arrangement in which only a linear control operation is performed. Also, by changing the length Tᵣₑₛ of the first period τ1, such an arrangement is capable of controlling the waveform of the power supply voltage Vdd. In the same way, by adjusting the length T_{end} of the second period τ2, such an arrangement is capable of controlling the waveform of the power supply voltage Vdd.

Description has been made regarding the prevent invention with reference to the embodiments. The above-described embodiments have been described for exemplary purposes only, and are by no means intended to be interpreted restrictively. Rather, various modifications may be made by making various combinations of the aforementioned components or processes. Description will be made below regarding such modifications.

Description has been made in the embodiment regarding an arrangement in which, during the first period τ1, the output current Iₒᵤₜ is increased in a linear manner. However, the present invention is not restricted to such an arrangement. For example, in the first period τ1, the output current Iₒᵤₜ may be changed in an exponential manner. Also, in the second period τ2, the output current Iₒᵤₜ may be changed in an exponential manner.

Description has been made in the embodiment regarding an arrangement in which the length of the first period τ1 and the length of the second period τ2 are each determined beforehand. However, the present invention is not restricted to such an arrangement. For example, an arrangement may be made in which the slope α of the output current Iₒᵤₜ in the first period τ1 is determined beforehand, and the first period τ1 is calculated based upon the slope α. Similarly, an arrangement may be made in which the slope β of the output current Iₒᵤₜ in the second period τ2 is determined beforehand, and the second period τ2 is calculated based upon the slope β.

Description has been made in the embodiment directing attention to a case in which a sharp increase occurs from a given level in the load current I_{L}. Also, the present invention can be effectively applied to a case in which a sharp drop occurs in the load current I_{L}. In this case, such an arrangement may preferably perform a control operation in which a charging operation is performed in the first period τ1 and a discharging operation is performed in the second period τ2 so as to provide a balance between the amount of charge in the charging operation and the amount of charge in the discharging operation, which is similar to what is described in the embodiment.

Description has been made in the embodiment regarding an arrangement configured to perform an operation so as to stabilize the power supply voltage Vdd in a short period of time. However, the present invention is not restricted to such an arrangement. By modification of the aforementioned various kinds of parameters, such as Nᵣₑₛ, N_{end}, etc., such an arrangement is capable of emulating various kinds of power supply performance.

In a case in which the output stage of the nonlinear control unit 20 is configured as a current source which is capable of controlling its output current Iₒᵤₜ, the current detection unit 30 may be omitted, and the control amount that is to be set for the current source may be used as the output current detection signal S2.

Description has been made in the embodiment regarding a power supply mounted on a test apparatus. However, the present invention is not restricted to such an arrangement. Rather, the present invention can be applied to a power supply apparatus configured to supply electric power to a wide range of general kinds of semiconductor devices and electronic circuits.

While the preferred embodiments of the present invention have been described using specific terms, such description is for illustrative purposes only, and it is to be understood that changes and variations may be made without departing from the spirit or scope of the appended claims.

What is claimed is:

1. A power supply apparatus configured to supply electric power via a power supply line to a semiconductor device having a power supply terminal connected to a capacitor, the power supply apparatus comprising:
a current detection unit configured to detect an output current output from the power supply apparatus; and
a nonlinear control unit configured to control its output amount so as to provide a balance between an amount of charge with which the capacitor is charged or discharged in a first period, from a first timing at which a change occurs in a load current that flows into the power supply terminal of the semiconductor device until a second timing at which the load current matches the output current, and an amount of charge with which the capacitor is charged or discharged in a second period, from the second timing until a third timing at which the control operation ends.

2. A power supply apparatus according to claim 1, wherein the nonlinear control unit comprises:
a load current calculation unit configured to calculate the load current that flows into the power supply terminal of the semiconductor device;
a charge amount calculation unit configured to calculate the amount of charge with which the capacitor is charged or discharged; and
an output amount calculation unit configured to calculate the output amount based upon the load current and the amount of charge thus calculated so as to provide a balance between the amount of charge for the first period and the amount of charge for the second period.

3. A power supply apparatus according to claim 2, wherein the load current calculation unit is configured to multiply the differential value of the power supply voltage at the power supply terminal by the capacitance value of the capacitor so as to calculate a charging/discharging current for the capacitor, and to subtract the charging/discharging current from the output current so as to calculate the load current.

4. A power supply apparatus according to claim 2, wherein the charge amount calculation unit is configured to integrate the difference between the load current and the output current so as to calculate the aforementioned amount of charge.

5. A power supply apparatus according to claim 3, wherein the charge amount calculation unit is configured to integrate the charging/discharging current so as to calculate the aforementioned amount of charge.

6. A power supply apparatus according to claim 2, wherein the length of the first period is determined beforehand.

7. A power supply apparatus according to claim 2, wherein the output amount calculation unit is configured to control the output amount such that the output current changes monotonically in the first period.

8. A power supply apparatus according to claim 2, wherein the length of the second period is determined beforehand.

9. A power supply apparatus according to claim 2, wherein the output amount calculation unit is configured to control the output amount such that the output current is maintained at a constant level in the second period.

10. A power supply apparatus according to claim 2, wherein the output amount calculation unit is configured to control the output amount such that the output current changes monotonically, and such that the output current becomes equal to the load current at the third timing, which is the endpoint of the second period.

11. A power supply apparatus according to claim 2, wherein the output amount calculation unit is configured to control the output amount such that the output current changes in an exponential manner, and such that the output current becomes equal to the load current at the third timing, which is the endpoint of the second period.

12. A power supply apparatus according to claim 1, further comprising a linear control unit configured to control its output amount such that the power supply voltage at the power supply terminal matches a predetermined reference voltage;
a load fluctuation detection unit configured to detect a change in the load; and
a selector configured to receive the output amount of the linear control unit and the output amount of the nonlinear control unit, to select one from among the output amounts thus received according to detection results obtained by the load fluctuation detection unit, and to output the output amount thus selected.

13. A power supply apparatus according to claim 12, wherein the load fluctuation detection unit is configured such that, when the difference between the power supply voltage and the reference voltage exceeds a predetermined threshold voltage, judgment is made that a change occurs in the load.

14. A power supply apparatus according to claim 12, wherein the load fluctuation detection unit is configured to detect a change in the load based upon the difference between the power supply voltage and the reference voltage.

15. A power supply apparatus according to claim 12, wherein the load fluctuation detection unit is configured to detect a change in the load based upon the aforementioned output current.

16. A power supply apparatus according to claim 12, wherein the load fluctuation detection unit is configured to detect a state in which a change occurs in the load, based upon a differential value of the aforementioned amount of charge.

17. A power supply apparatus according to claim 12, wherein the load fluctuation detection unit is configured to detect a state in which a change occurs in the load, based upon a differential value of the aforementioned load current.

18. A test apparatus comprising a power supply apparatus configured to supply electric power via a power supply line to a semiconductor device having a power supply terminal connected to a capacitor,
wherein the power supply apparatus comprises:
a current detection unit configured to detect an output current output from the power supply apparatus; and
a nonlinear control unit configured to control its output amount so as to provide a balance between an amount of charge with which the capacitor is charged or discharged in a first period, from a first timing at which a change occurs in a load current that flows into the power supply terminal of the semiconductor device until a second timing at which the load current matches the output current, and an amount of charge with which the capacitor is charged or discharged in a second period, from the second timing until a third timing at which the control operation ends.

19. A control method for a power supply apparatus configured to supply electric power via a power supply line to a semiconductor device having a power supply terminal connected to a capacitor, the control method comprising:
detecting an output current output from a control terminal of the power supply apparatus; and
controlling its output amount so as to provide a balance between an amount of charge with which the capacitor is charged or discharged in a first period, from a first timing at which a change occurs in a load current that flows into the power supply terminal of the semiconductor device until a second timing at which the load current matches the output current, and an amount of charge with which the capacitor is charged or discharged in a second period, from the second timing until a third timing at which the control operation ends.

20. A control method according to claim 19, wherein the aforementioned control of the output amount comprises:
calculating the load current that flows into the power supply terminal of the semiconductor device;
calculating the amount of charge with which the capacitor is charged or discharged; and
calculating the output amount based upon the load current and the amount of charge thus calculated so as to provide a balance between the amount of charge for the first period and the amount of charge for the second period.

21. A control method according to claim 20, wherein, in the aforementioned calculation of the output amount, the differential value of the power supply voltage at the power supply terminal is multiplied by the capacitance value of the capacitor so as to calculate a charging/discharging current for the capacitor, and the charging/discharging current is subtracted from the output current so as to calculate the load current.

22. A control method according to claim 20, wherein, in the aforementioned calculation of the amount of charge, the difference between the load current and the output current is integrated so as to calculate the aforementioned amount of charge.

23. A control method according to claim 21, wherein, in the aforementioned calculation of the amount of charge, the charging/discharging current is integrated so as to calculate the aforementioned amount of charge.

24. A control method for a power supply apparatus configured to supply electric power via a power supply line to a semiconductor device having a power supply terminal connected to a capacitor, the control method comprising:
detecting an output current output from a control terminal of the power supply apparatus;
detecting a change in the load so as to judge whether the load is in a static state or in a transient state;
controlling the output amount in the load static state such that the power supply voltage at the power supply terminal matches a predetermined reference voltage;
controlling the output amount in the load transient state so as to provide a balance between an amount of charge with which the capacitor is charged or discharged in a first period, from a first timing at which a change occurs in a load current that flows into the power supply terminal of the semiconductor device until a second timing at which the load current matches the output current, and an amount of charge with which the capacitor is charged or discharged in a second period, from the second timing until a third timing at which the control operation ends.
